(19) United States
(12) Patent Application Publication
(10) Pub. No.: US 2026/0331400 A1
(43) Pub. Date: Oct. 22, 2026

(54) ROCKER SWITCH FOR DIMMING

(71) Applicant: Jiangsu Barep Smart Technology Co.,Ltd, Zhangjiagang (CN)

(72) Inventors: Jiangang Chen, Zhangjiagang (CN); Xiaobo Zheng, Zhangjiagang (CN)

(21) Appl. No.: 19/707,309

(22) Filed: Jun. 14, 2026

(30) Foreign Application Priority Data
May 14, 2026 (CN) 202620679053.9

(51) Int. Cl. H01H 23/00; H01C 10/50; H01H 9/18; H01H 15/10; H01H 23/04; H01H 23/14

(52) U.S. Cl. CPC H01H 23/003; H01C 10/50; H01H 9/18; H01H 15/10; H01H 23/006; H01H 23/04; H01H 23/145

(57) ABSTRACT

A rocker switch for dimming is provided, including a switch base in which a printed circuit board (PCB) is arranged, where a supporting member is fixedly mounted on the PCB; symmetrically disposed fixed contacts are arranged on two sides of the supporting member; the fixed contacts are fixedly mounted on the PCB; a switch cover plate detachably mounted on the switch base, where the switch cover plate is provided with a button slot; a connector tube corresponding to the supporting member is arranged on a bottom surface of the button slot; positioning slots are formed in opposite side walls of the connector tube; a rocker plate placed inside the positioning slot, where a middle portion of the rocker plate is in contact with the supporting member; symmetrically disposed positioning portions are arranged on two sides of the rocker plate.

### TECHNICAL FIELD

The present disclosure relates to the technical field of rocker switches, and in particular, to a rocker switch for dimming.

### BACKGROUND

A rocker switch is a self-locking power control element that achieves circuit connection and disconnection through mechanical pressing. When a rocker switch is used, one side of a rocker is pressed, and an internal metal reed pushes a movable contact to be in contact with a fixed contact, thereby implementing circuit connection.

In a conventional rocker switch structure, to fix the fixed contact on the PCB, two contact points need to be riveted onto a lead-out sheet, and then the lead-out sheet is fixed to the PCB through wave soldering. As a result, the fixed contact requires multiple processing procedures, and the material costs are high. In addition, the reliability of connection between the contact and the PCB is poor.

In addition, since the rocker switch for dimming is provided with a sliding potentiometer, and a toggle piece of the sliding potentiometer slides in a length direction of the rocker switch to adjust the brightness of light of a light-emitting diode (LED) lamp. A sliding chute of the toggle piece restricts a width of a button. Consequently, a contact area during pressing of the button is small, and the pressing experience is poor. Moreover, the toggle piece is exposed out of the button, which easily causes mis-operations.

### SUMMARY

An objective of the present disclosure is to provide a rocker switch for dimming, to solve the problems of poor reliability of connection to a fixed contact of the existing rocker switch for dimming, high processing costs, and ease of mis-operation on a toggle piece.

To achieve the foregoing objective, the present disclosure adopts the following technical solutions: a rocker switch for dimming, including:
a switch base in which a PCB is arranged, where a supporting member is fixedly mounted on the PCB; symmetrically disposed fixed contacts are arranged on two sides of the supporting member; the fixed contacts are fixedly mounted on the PCB;
a switch cover plate detachably mounted on the switch base, where the switch cover plate is provided with a button slot; a connector tube corresponding to the supporting member is arranged on a bottom surface of the button slot; positioning slots are formed in opposite side walls of the connector tube;
a rocker plate placed inside the positioning slot, where a middle portion of the rocker plate is in contact with the supporting member; symmetrically disposed positioning portions are arranged on two sides of the rocker plate; the positioning portions extend into the positioning slot; and
a button rotatably mounted on the switch cover plate, where a pushing shaft is arranged on a back surface of the button; the pushing shaft is elastically connected to the button; and a bottom end of the pushing shaft is in contact with the rocker plate.

In a further description of the foregoing technical solution:

A sliding potentiometer is further arranged inside the switch base. A first toggle piece for adjusting brightness of a lamp is arranged on the sliding potentiometer. A protruding portion is arranged on a side wall of the button slot. A first notch for keeping clear of the protruding portion is provided on the button. A sliding chute is arranged on the protruding portion. The first toggle piece passes through the sliding chute.

In a further description of the foregoing technical solution:
a lower limit trimming potentiometer is further arranged inside the switch base. The lower limit trimming potentiometer is provided with a second toggle piece. A top end of the second toggle piece is bent toward one side away from the sliding potentiometer to form a toggle portion. A second notch for keeping clear of the toggle portion is provided on a side wall of the switch cover plate.

In a further description of the foregoing technical solution:
an identification slot corresponding to the second notch is provided on the switch base.

In a further description of the foregoing technical solution:
a plurality of parallel antiskid convex ribs are arranged on a surface of the toggle portion.

In a further description of the foregoing technical solution:
symmetrically disposed connection cylinders are arranged on opposite side walls of the button slot. First slopes are arranged at end portions of the connection cylinders. Connection slots corresponding to the connection cylinders are provided on side walls of the button. Flared openings are formed in bottoms of the connection slots. Second slopes are arranged on bottom surfaces of the connection slots at the openings. Blind holes are further formed in the bottom surfaces of the connection slots.

In summary, by using the foregoing technical solution, the present disclosure has the beneficial effects:
1. In the present disclosure, the fixed contacts of the rocker switch for dimming are directly fixed to the PCB by wave soldering, so that the fixed contacts are in contact with the PCB reliably. This eliminates a traditional lead-out sheet, reduces procedures while reducing material costs, and effectively solves the problems of poor reliability of connection to the fixed contacts of the existing rocker switch for dimming and high processing costs.
2. In the present disclosure, the rocker switch uses the button to hide and protect the first toggle piece of the sliding potentiometer to avoid mis-operation. Meanwhile, the widths of pressing portions at the two ends of the button will not be affected; a contact area during pressing of the button is enlarged; and the pressing experience is optimized.
3. In the present disclosure, the lower limit trimming potentiometer and the sliding potentiometer are respectively arranged on two sides of the switch cover plate, and the toggle portion of the second toggle piece is hidden by the switch cover plate, to avoid mis-operation.

### BRIEF DESCRIPTION OF THE DRAWINGS

For clearer descriptions of the technical solutions of the embodiments of the present disclosure, the drawings required to be used in the embodiments are briefly introduced below. It should be understood that the drawings below are only some embodiments of the present disclosure. Therefore, the embodiments shall not be regarded as limitations on the scope. A person of ordinary skill in the art can also obtain other relevant drawings according to these drawings without creative work.

FIG. 1 is a schematic diagram of a structure of a rocker switch for dimming.

FIG. 2 is cross-sectional view I of a rocker switch for dimming.

FIG. 3 is cross-sectional view II of a rocker switch for dimming.

FIG. 4 is a schematic exploded diagram I of a structure of a rocker switch for dimming.

FIG. 5 is a schematic exploded diagram II of a structure of a rocker switch for dimming.

FIG. 6 is a partially enlarged view of part A in FIG. 5.

### REFERENCE NUMERALS

1: switch base; 11: PCB; 111: supporting member; 112: fixed contact; 12: sliding potentiometer; 121: first toggle piece; 13: lower limit trimming potentiometer; 131: second toggle piece; 1311: toggle portion; 14: identification slot;
2: switch cover plate; 21: button slot; 211: protruding portion; 2111: sliding chute; 212: connection cylinder; 22: connector tube; 221: positioning slot; 23: second notch;
3: rocker plate; 31: positioning portion;
4: button; 41: pushing shaft; 42: first notch; 43: connection slot; 431: second slope; and 432: blind hole.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

### Embodiment 1

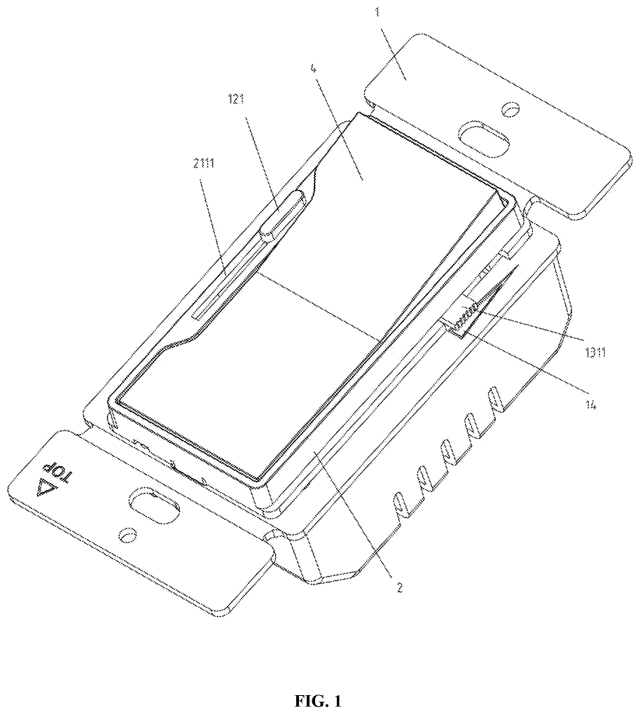

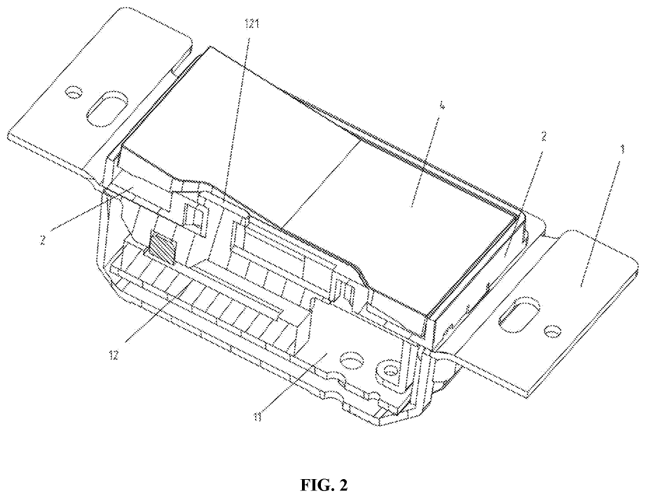

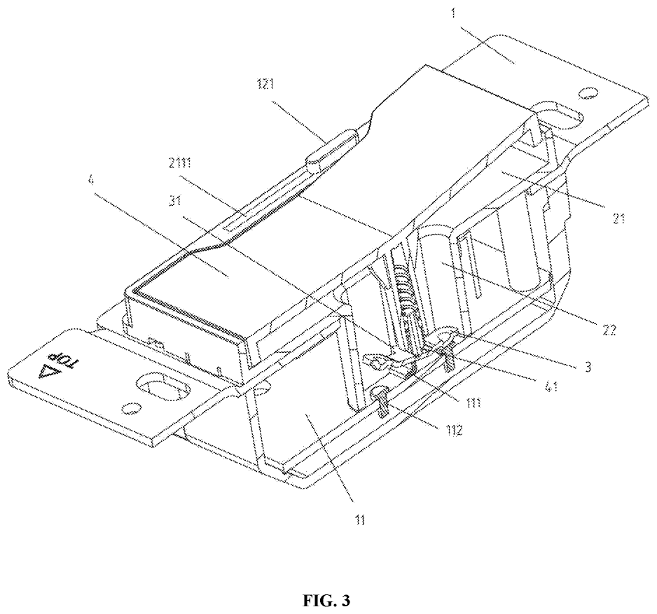

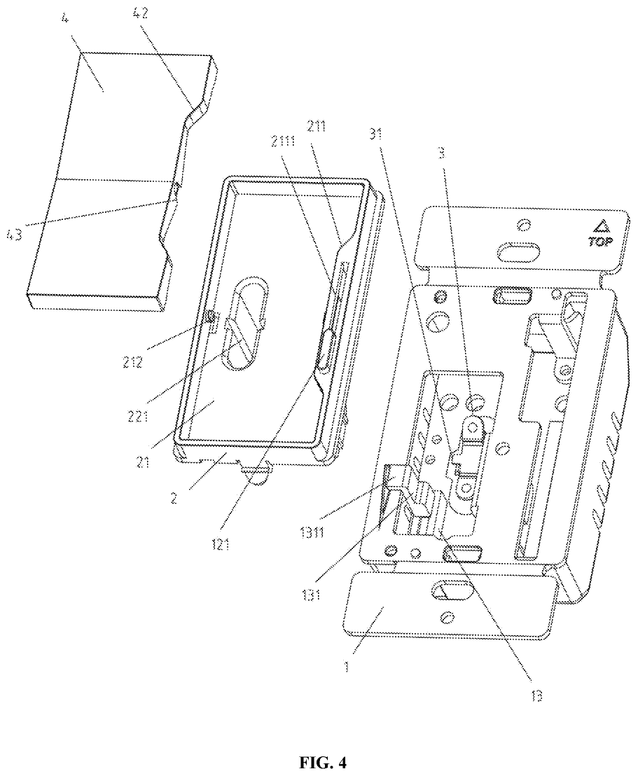

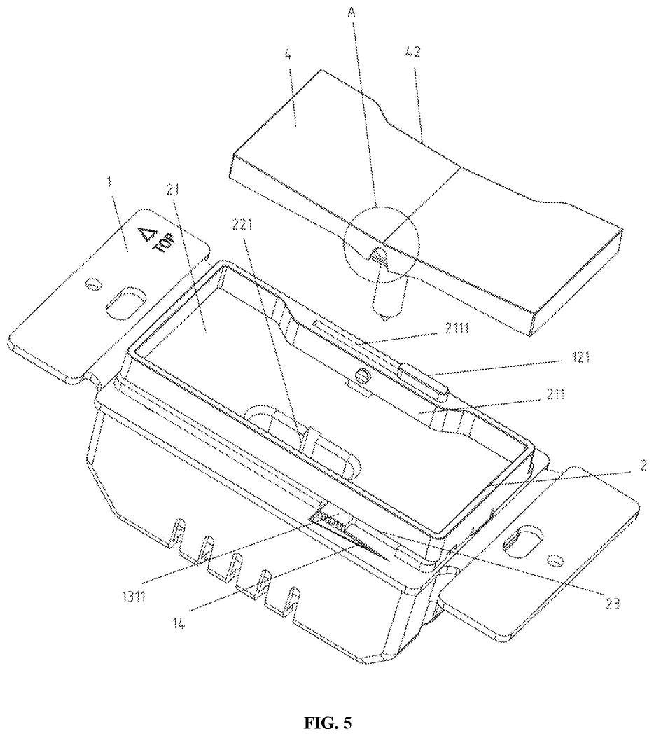

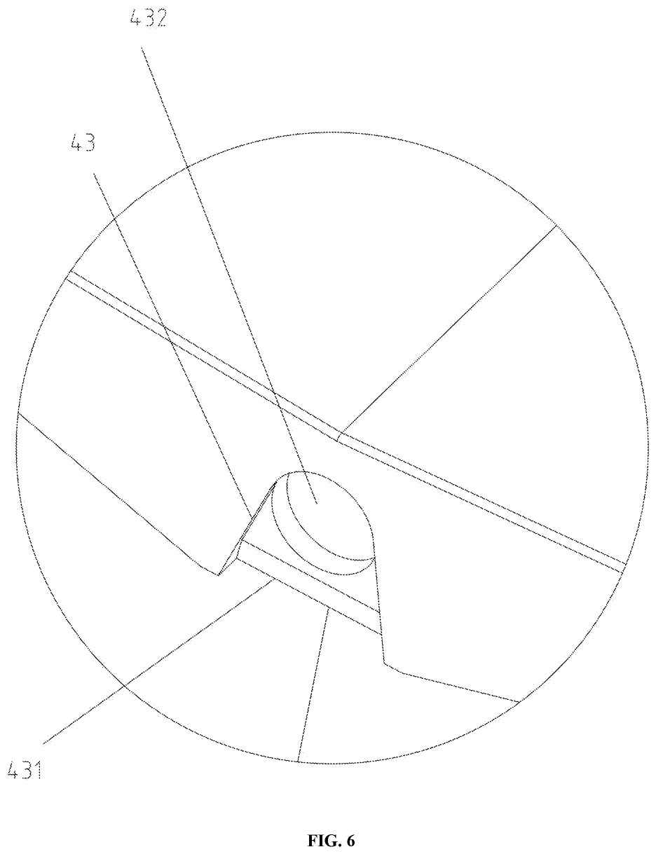

Referring to FIG. 1 to FIG. 6, the present disclosure provides a technical solution: a rocker switch for dimming, including:
a switch base 1 in which a PCB 11 is arranged, where a supporting member 111 is fixedly mounted on the PCB 11; symmetrically disposed fixed contacts 112 are arranged on two sides of the supporting member 111; the fixed contacts 112 are fixedly mounted on the PCB 11;
a switch cover plate 2 detachably mounted on the switch base 1, where the switch cover plate 2 is provided with a button slot 21; a connector tube 22 corresponding to the supporting member 111 is arranged on a bottom surface of the button slot 21; positioning slots 221 are formed in opposite side walls of the connector tube 22;
a rocker plate 3 placed inside the positioning slot 221, where a middle portion of the rocker plate 3 is in contact with the supporting member 111; symmetrically disposed positioning portions 31 are arranged on two sides of the rocker plate 3; the positioning portions 31 extend into the positioning slots 221, so that the rocker plate 3 and the connector tube 22 form a rotatably mounted structure; symmetrically disposed movable contacts are arranged at two ends of the rocker plate 3; the movable contacts are configured to be in contact with the fixed contacts 112, to control circuit connection and disconnection; and
a button 4 rotatably mounted on the switch cover plate 2, where a pushing shaft 41 is arranged on a back surface of the button 4; the pushing shaft 41 is elastically connected to the button 4; and a bottom end of the pushing shaft 41 is in contact with the rocker plate 3. Specifically, the pushing shaft 41 is arranged inside a connection column on the back surface of the button 4. A spring is arranged inside the connection column. One end of the spring is in contact with the pushing shaft 41, and another opposite end is in contact with an inner wall of the connection column, thereby achieving elastic connection to the pushing shaft 41.

A sliding potentiometer 12 is further arranged inside the switch base 1. A first toggle piece 121 for adjusting brightness of a lamp is arranged on the sliding potentiometer 12. A protruding portion 211 is arranged on a side wall of the button slot 21. A first notch 42 for keeping clear of the protruding portion 211 is provided on the button 4. A sliding chute 2111 is arranged on the protruding portion 211. The first toggle piece 121 passes through the sliding chute 2111.

The rocker switch uses the button 4 to hide and protect the first toggle piece 121 of the sliding potentiometer 12 to avoid mis-operation. Meanwhile, the widths of pressing portions at the two ends of the button will not be affected; a contact area during pressing of the button is enlarged; and the pressing experience is optimized.

Working principle: When the button 4 is rotated, the pushing shaft 41 on its back surface pushes the rocker plate 3, so that the rocker plate 3 rotates under the supporting of the support member 111. This causes the movable contacts on the rocker plate 3 to be in contact with the fixed contacts 112 on the PCB 11, thereby implementing circuit connection or disconnection. The fixed contacts 112 of the rocker switch for dimming are directly fixed to the PCB 11 by wave soldering, so that the fixed contacts 112 are in contact with the PCB reliably. This eliminates a traditional lead-out sheet, reduces procedures while reducing material costs, and effectively solves the problems of poor reliability of connection to the fixed contacts of the existing rocker switch for dimming and high processing costs.

### Embodiment 2

Based on the foregoing embodiment, this embodiment further makes the following improved technical solution: a lower limit trimming potentiometer 13 is further arranged inside the switch base 1. The lower limit trimming potentiometer 13 is provided with a second toggle piece 131. A top end of the second toggle piece 131 is bent toward one side away from the sliding potentiometer 12 to form a toggle portion 1311. A second notch 23 for keeping clear of the toggle portion 1311 is provided on a side wall of the switch cover plate 2. In addition, a plurality of parallel antiskid convex ribs are arranged on a surface of the toggle portion 1311 to increase the roughness of the surface of the toggle portion 1311. It facilitates pushing of the second toggle piece 131.

The lower limit trimming potentiometer 13 is also referred to as a “low-end regulator” and is configured to adjust a minimum brightness level of a dimmer (i.e. the rocker switch for dimming). The second toggle piece 131 of the lower limit trimming potentiometer 13 can be found after a decorative panel is removed from the dimmer. By sliding and adjusting the second toggle piece 131, a minimum dimming brightness value of an LED lamp connected to the dimmer can be adjusted, with a fine-tunning limit of 0.1%. That is, when the brightness of the LED lamp is adjusted subsequently by using the sliding potentiometer 12, the brightness of the lamp will not exceed a lower limit set by the lower limit trimming potentiometer 13.

The lower limit trimming potentiometer 13 and the sliding potentiometer 12 are respectively arranged on two sides of the switch cover plate 2, and the toggle portion 1311 of the second toggle piece 131 is hidden by the switch cover plate 2, to avoid mis-operation.

### Embodiment 3

Based on the foregoing embodiment, this embodiment further makes the following improved technical solution: an identification slot 14 corresponding to the second notch 23 is provided on the switch base 1.

The identification slot 14 is configured to achieve physical identification on an adjustment effect of the second toggle piece 131. Specifically, a triangular structure as shown in the accompanying drawing can be used to visually indicate an adjustment direction.

### Embodiment 4

Based on the foregoing embodiment, this embodiment further makes the following improved technical solution: symmetrically disposed connection cylinders 212 are arranged on opposite side walls of the button slot 21. First slopes are arranged at end portions of the connection cylinders 212. Connection slots 43 corresponding to the connection cylinders 212 are provided on side walls of the button 4. Flared openings are formed in bottoms of the connection slots 43. Second slopes 431 are arranged on bottom surfaces of the connection slots 43 at the openings. Blind holes 432 are further formed in the bottom surfaces of the connection slots 43.

During mounting of the button 4, the second slopes 431 at the openings in the bottoms of the connection slots 43 are matched with the first slopes of the connection cylinders 212 on the side walls of the button slot 21, making it easy to snap the connection cylinders 212 into the blind holes 432 on the side walls of the button 4, to implement the rotatable mounting of the button 4.

The above is only the specific implementation of the present disclosure, but the protection scope of the present disclosure is not limited to this. Equivalent replacements or changes made by any person skilled in the art within the technical scope disclosed in the present disclosure based on the technical solutions and concept of the present disclosure shall all fall within the protection scope of the present disclosure.

What is claimed is:

1. A rocker switch for dimming, comprising:
a switch base in which a printed circuit board (PCB) is arranged, wherein a supporting member is fixedly mounted on the PCB; symmetrically disposed fixed contacts are arranged on two sides of the supporting member; the fixed contacts are fixedly mounted on the PCB;
a switch cover plate detachably mounted on the switch base, wherein the switch cover plate is provided with a button slot; a connector tube corresponding to the supporting member is arranged on a bottom surface of the button slot; positioning slot are formed in opposite side walls of the connector tube;
a rocker plate placed inside the positioning slot, wherein a middle portion of the rocker plate is in contact with the supporting member; symmetrically disposed positioning portions are arranged on two sides of the rocker plate; the positioning portions extend into the positioning slot; and
a button rotatably mounted on the switch cover plate, wherein a pushing shaft is arranged on a back surface of the button; the pushing shaft is elastically connected to the button; and a bottom end of the pushing shaft is in contact with the rocker plate.

2. The rocker switch for dimming according to claim 1, wherein a sliding potentiometer is further arranged inside the switch base; a first toggle piece for adjusting brightness of a lamp is arranged on the sliding potentiometer; a protruding portion is arranged on a side wall of the button slot; a first notch for keeping clear of the protruding portion is provided on the button; a sliding chute is arranged on the protruding portion; and the first toggle piece passes through the sliding chute.

3. The rocker switch for dimming according to claim 1, wherein a lower limit trimming potentiometer is further arranged inside the switch base; the lower limit trimming potentiometer is provided with a second toggle piece; a top end of the second toggle piece is bent toward one side away from the sliding potentiometer to form a toggle portion; and a second notch for keeping clear of the toggle portion is provided on a side wall of the switch cover plate.

4. The rocker switch for dimming according to claim 3, wherein an identification slot corresponding to the second notch is provided on the switch base.

5. The rocker switch for dimming according to claim 3, wherein a plurality of parallel antiskid convex ribs are arranged on a surface of the toggle portion.

6. The rocker switch for dimming according to claim 1, wherein symmetrically disposed connection cylinders are arranged on opposite side walls of the button slot; first slopes are arranged at end portions of the connection cylinders; connection slots corresponding to the connection cylinders are provided on side walls of the button; flared openings are formed in bottoms of the connection slots; second slopes are arranged on bottom surfaces of the connection slots at the openings; and blind holes are further formed in the bottom surfaces of the connection slots.
